(19) United States
(12) Patent Application Publication
(10) Pub. No.: US 2023/0382198 A1
(43) Pub. Date: Nov. 30, 2023

(54) Wind Deflection Assembly

(71) Applicant: Daryl Stewart, Texas City, TX (US)

(72) Inventor: Daryl Stewart, Texas City, TX (US)

(21) Appl. No.: 17/827,860

(22) Filed: May 30, 2022

(51) Int. Cl. B60J 1/20; B60J 7/22

(52) U.S. Cl. CPC B60J 1/20; B60J 7/22

(57) ABSTRACT

A wind deflection assembly includes a golf cart that has a roof and a driver's seat. A deflector is provided which has an angled portion forming an angle with a mounting portion. The mounting portion is positionable against the roof having the angled portion angling downwardly from the roof. The deflector is comprised of a rigid material thereby facilitating the angled portion to deflect wind downwardly when the golf cart is in motion. Additionally, the deflector is aligned with the driver's seat such that the angled portion directs the wind onto a driver of the golf cart to cool the driver.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to deflection devices and more particularly pertains to a new deflection device for deflecting wind onto a driver of a golf cart to cool the driver. The device includes a deflector which is mounted to roof of a golf cart and which includes an angled portion angling downwardly from the roof. The deflector is aligned with a driver's seat of the golf cart such that the angled portion deflects wind downwardly onto the driver's seat when the golf cart is in motion. In this way the driver can be cooled by the deflected wind while the driver is driving the golf cart.

### (2) Description of Related Art Including Information Disclosed Under 37 CFR 1.97 and 1.98

The prior art relates to deflection devices including a window screen that is mounted to a front end of a golf cart. The prior art discloses a cooling device that includes a misting unit coupled to a roof of a golf cart for dispensing a cooling mist onto occupants of the golf cart. The prior art discloses a windshield retaining bracket that is mountable to a frame of a golf cart roof. The prior art discloses a variety of windshield devices that are mountable to a frame of a golf cart roof.

### BRIEF SUMMARY OF THE INVENTION

An embodiment of the disclosure meets the needs presented above by generally comprising a golf cart that has a roof and a driver's seat. A deflector is provided which has an angled portion forming an angle with a mounting portion. The mounting portion is positionable against the roof having the angled portion angling downwardly from the roof. The deflector is comprised of a rigid material thereby facilitating the angled portion to deflect wind downwardly when the golf cart is in motion. Additionally, the deflector is aligned with the driver's seat such that the angled portion directs the wind onto a driver of the golf cart to cool the driver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a wind deflection assembly according to an embodiment of the disclosure.

FIG. 2 is a left side view of an embodiment of the disclosure.

FIG. 3 is a back view of an embodiment of the disclosure.

FIG. 4 is a perspective in-use view of an embodiment of the disclosure.

FIG. 5 is a front view of an alternative embodiment of the disclosure.

### DETAILED DESCRIPTION OF THE INVENTION

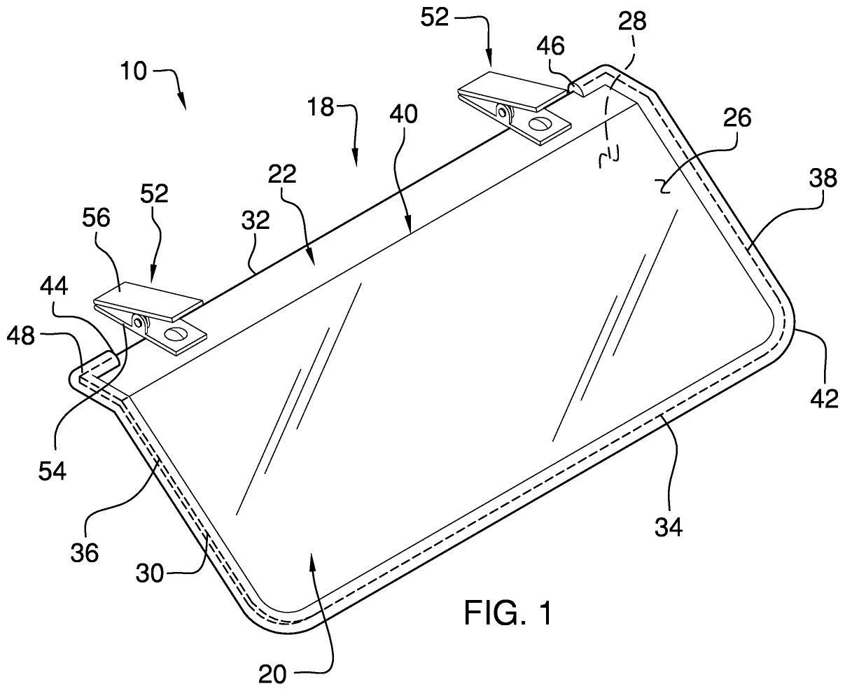

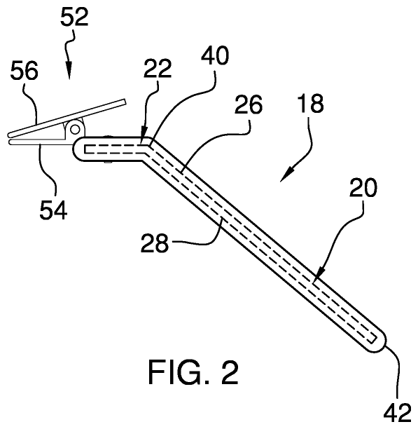

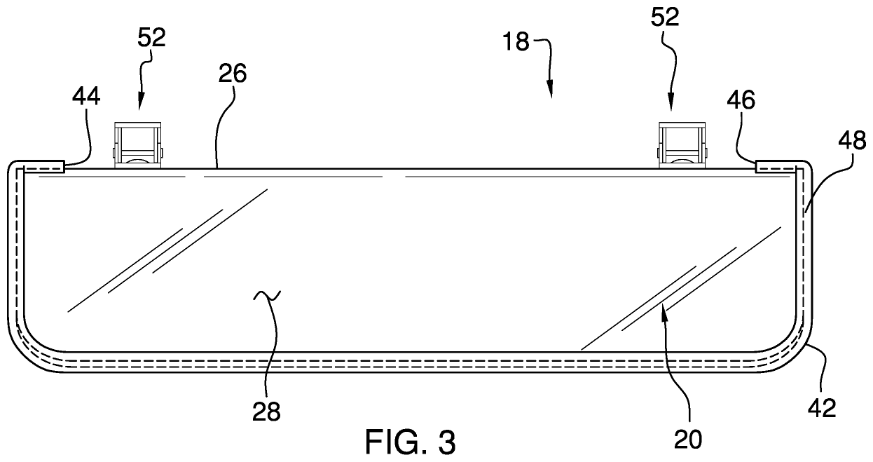

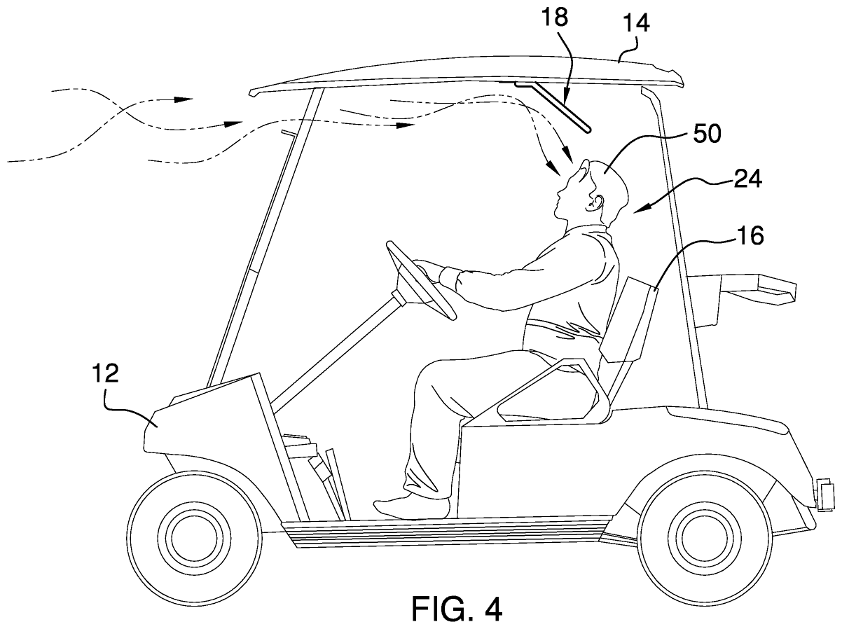

With reference now to the drawings, and in particular to FIGS. 1 through 5 thereof, a new deflection device embodying the principles and concepts of an embodiment of the disclosure and generally designated by the reference numeral 10 will be described.

As best illustrated in FIGS. 1 through 5, the wind deflection assembly 10 generally comprises a golf cart 12 that has a roof 14 and a driver's seat 16. The golf cart 12 may be an electric golf cart, a gas golf cart or any other type of motorized cart that has a roof. A deflector 18 is provided that has an angled portion 20 forming an angle with a mounting portion 22. The mounting portion 22 is positionable against the roof 14 having the angled portion 20 angling downwardly from the roof 14. The deflector 18 is comprised of a rigid material thereby facilitating the angled portion 20 to deflect wind downwardly when the golf cart 12 is in motion. Furthermore, the deflector 18 is aligned with the driver's seat 16 such that the angled portion 20 directs the wind onto a driver 24 of the golf cart 12 to cool the driver 24. In this way the driver 24 can enjoy relief from summer temperatures while the driver 24 is driving the golf cart 12.

The deflector 18 has a top surface 26, a bottom surface 28 and a perimeter edge 30 extending between the top surface 26 and the bottom surface 28, and the perimeter edge 30 has a front side 32, a back side 34, a first lateral side 36 and a second lateral side 38. The deflector 18 has a bend 40 extending between the first lateral side 36 and the second lateral side 38 to define the mounting portion 22 and the angled portion 20. The mounting portion 22 is associated with the front side 32 of the perimeter edge 30 and the angled portion 20 is associated with the back side 34 of the perimeter edge 30. Additionally, the bend 40 is positioned closer to the front side 32 than the back side 34. The mounting portion 22 may have a length of approximately 2.5 cm, the angled portion 20 may have a length of approximately 12.5 cm and the deflector 18 may have a width of approximately 30.0 cm.

A tube 42 is provided that has a first end 44, a second end 46 and an outer wall 48 extending between the first end 44 and the second end 46, and the outer wall 48 is split between the first end 44 and the second end 46. In this way the outer wall 48 can receive the perimeter edge 30 of the deflector 18. The tube 42 extends along the back side 34 and the first lateral side 36 and the second lateral side 38 of the perimeter edge 30 such that each of the first end 44 and the second end 46 of the tube 42 are positioned on the front side 32 of the perimeter edge 30. Additionally, the tube 42 may be comprised of a resiliently compressible material, such as rubber for example, to inhibit the perimeter edge 30 of the deflector 18 from injuring the user's head 50.

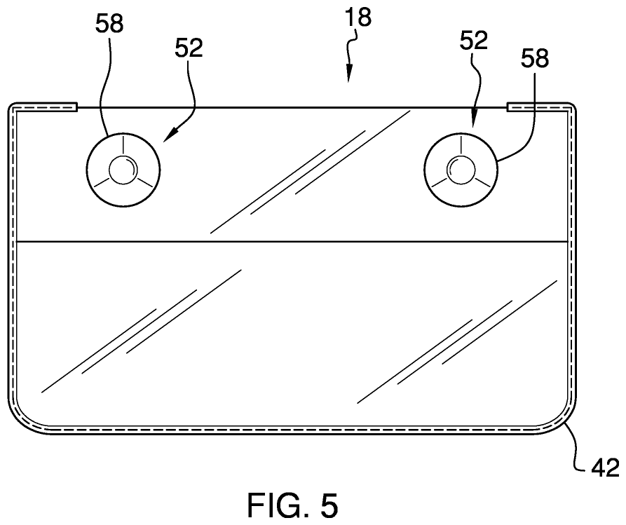

A pair of attaching elements 52 is provided and each of the attaching elements 52 is coupled to the deflector 18. Each of the attaching elements 52 releasably engages the roof 14 of the golf cart 12 for mounting the deflector 18 to the roof 14. Each of the attaching elements 52 is positioned on the top surface 26 of the deflector 18 and each of the attaching elements 52 is positioned on the mounting portion 22 of the deflector 18. Furthermore, each of the attaching elements 52 is positioned adjacent to the front side 32 of the perimeter edge 30 and each of the attaching elements 52 is spaced from a respective one of the first end 44 and the second end 46 of the tube 42. As is most clearly shown in FIGS. 1 through 4, each of the attaching elements 52 may include a first jaw 54 that pivotally engages a second jaw 56, and the first jaw 54 of each attaching element 52 may be attached to the deflector 18. The first jaw 54 and second jaw 56 may be biased together for clamping to a structural element of the roof 14. As is most clearly shown in FIG. 5, each of the attaching elements 52 may comprise a section cup 58 that suctionally engages a bottom surface 28 of the roof 14. Alternatively, the deflector 18 may be a unitary structure of the roof 14 that is incorporated into the golf cart 12 during the manufacturing process of the golf cart 12.

In use, the deflector 18 is mounted to the roof 14 such and the deflector 18 is oriented such that the angled portion 20 angles toward a rear end 60 of the golf cart 12. Furthermore, the deflector 18 is oriented to be aligned with the driver's seat 16. In this way the angled portion 20 directs wind downwardly onto the driver 24 when the driver 24 is driving the golf cart 12. Thus, the driver 24 can be cooled off by the deflected wind thereby enhancing comfort for the driver 24 during hot weather.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A wind deflection assembly comprising:
a golf cart having a roof and a driver's seat; and
a deflector having an angled portion forming an angle with a mounting portion, said mounting portion being positionable against said roof having said angled portion angling downwardly from said roof, said deflector being comprised of a rigid material thereby facilitating said angled portion to deflect wind passing from under a front of the roof and rearwardly along a bottom of the roof downwardly when said golf cart is in motion, said deflector being aligned with said driver's seat such that said angled portion directs the wind onto a driver of the golf cart wherein said deflector is configured to cool the driver.

2. The assembly according to claim 1, wherein said deflector has a top surface, a bottom surface and a perimeter edge extending between said top surface and said bottom surface, said perimeter edge having a front side, a back side, a first lateral side and a second lateral side, said deflector having a bend extending between said first lateral side and said second lateral side to define said mounting portion and said angled portion, said mounting portion being associated with said front side of said perimeter edge, said angled portion being associated with said back side of said perimeter edge, said bend being positioned closer to said front side than said back side.

3. The assembly according to claim 2, wherein
said assembly includes a tube having a first end, a second end and an outer wall extending between said first end and said second end, said outer wall being split between said first end and said second end thereby facilitating said outer wall to receive said perimeter edge of said deflector, said tube extending along said back side and said first lateral side and said second lateral side of said perimeter edge such that each of said first end and said second end of said tube are positioned on said front side of said perimeter edge.

4. The assembly according to claim 3, further comprising a pair of attaching elements, each of said attaching elements being coupled to said deflector, each of said attaching elements releasably engaging said roof of said golf cart for mounting said deflector to said roof, each of said attaching elements being positioned on a top surface of said deflector, each of said attaching elements being positioned on said mounting portion of said deflector, each of said attaching elements being positioned adjacent to said front side of said perimeter edge, each of said attaching elements being spaced from a respective one of said first end and said second end of said tube.

5. A wind deflection assembly comprising:
a golf cart having a roof and a driver's seat;
a deflector having an angled portion forming an angle with a mounting portion, said mounting portion being positionable against said roof having said angled portion angling downwardly from said roof, said deflector being comprised of a rigid material thereby facilitating said angled portion to deflect wind passing from under a front of the roof and rearwardly along a bottom of the roof downwardly when said golf cart is in motion, said deflector being aligned with said driver's seat such that said angled portion directs the wind onto a driver of the golf cart wherein said deflector is configured to cool the driver, said deflector having a top surface, a bottom surface and a perimeter edge extending between said top surface and said bottom surface, said perimeter edge having a front side, a back side, a first lateral side and a second lateral side, said deflector having a bend extending between said first lateral side and said second lateral side to define said mounting portion and said angled portion, said mounting portion being associated with said front side of said perimeter edge, said angled portion being associated with said back side of said perimeter edge, said bend being positioned closer to said front side than said back side;
a tube having a first end, a second end and an outer wall extending between said first end and said second end, said outer wall being split between said first end and said second end thereby facilitating said outer wall to receive said perimeter edge of said deflector, said tube extending along said back side and said first lateral side and said second lateral side of said perimeter edge such that each of said first end and said second end of said tube are positioned on said front side of said perimeter edge; and
a pair of attaching elements, each of said attaching elements being coupled to said deflector, each of said attaching elements releasably engaging said roof of said golf cart for mounting said deflector to said roof, each of said attaching elements being positioned on said top surface of said deflector, each of said attaching elements being positioned on said mounting portion of said deflector, each of said attaching elements being positioned adjacent to said front side of said perimeter edge, each of said attaching elements being spaced from a respective one of said first end and said second end of said tube.
